(19) United States
(12) Patent Application Publication
(10) Pub. No.: US 2003/0223733 A1
(43) Pub. Date: Dec. 4, 2003

(54) System and method of processing audio/video data in a remote monitoring system

(75) Inventor: Hosung Chang, Holtsville, NY (US)

Correspondence Address: Frank Chau, F. CHAU & ASSOCIATES, LLP, Suite 501, 1900 Hempstead Turnpike, East Meadow, NY, 11554, US

(73) Assignee: Intelligent Digital Systems LLC

(21) Appl. No.: 10/279,279

(22) Filed: Oct. 24, 2002

Related U.S. Application Data
(63) Continuation-in-part of application No. 10/145,058, filed on May 14, 2002.

(51) Int. Cl. H04N 5/781

(52) U.S. Cl. 386/69; 386/70

(57) ABSTRACT

A method for key play base transfer of a video between a server and a client over a network comprises initializing a session between the server and the client, wherein a key frame index is transferred to the client from the server. The method further comprises receiving a client request for content at the server, wherein the request comprises a key frame pointer and a parameter specifing a packet length, and sending a packet to the client in response to the request for content from the server, wherein the packet is a variable length according to the parameter.

### BACKGROUND OF THE INVENTION

1. Field of the Invention

The present invention relates to video manipulation, and more particularly to a system and method for multichannel video surveillance.

2. Discussion of Related Art

Video monitoring systems can comprise a data processing module for processing video data provided from local and remote sources. Referring to FIG. 1, a block diagram is provided for illustrating a data processing module 10. The data processing module 10 comprises a video data capture device 11 for capturing video data transmitted from video sources VS1-VS3 such as cameras. The video sources VS1-VS3 can be located in areas local to or remote to the data processing module 10. The video data capture device 11 processes the video signals VS1-VS3 from the video sources to provide digital video data.

The data processing module 10 can comprise a driver 13 for driving the video data capture device 11. The driver 13 can be a program routine that links a peripheral device to an operating system of the data processing module 10. In the data processing module 10, the driver 13 drives the video data capture device 11 so that video data output from the video data capture device 11 is processed according to an application program associated with the driver 13.

Video data provided through the driver 13 can be transmitted to a user interface 15, which can comprise a display unit to display the video data. The transmission of video data from the driver 13 to the user interface 15 can be controlled by a control unit 17 to which a user can provide user input data. The video data from the driver 13 can be transferred to, and stored in, a data storage medium 19 under the control of the control unit 17.

In a conventional monitoring system, the video data capture device 11 can be coupled to one or more audio sources such as microphones. The audio sources obtain sound from the areas to be monitored and provide audio signals to the video data capture device 11. In this case, the video data capture device 11 also has a function of capturing and processing audio signals from the audio sources to produce digital audio data.

However, in the data processing system for a conventional monitoring system, there is generally a limit to the amount of video data captured and recorded. For example, video data capture devices process a single input video signal at a maximum speed of thirty (30) frames per second. This rate can decrease with additional input video signals.

Conventional data processing systems typically have one audio channel between audio sources and a user interface or a data storage device. The conventional data processing system does not provide channels through which two-way communication is feasible between a user interface and audio sources. Typically, in the conventional monitoring system, only one audio channel is provided for recording audio data.

Since the data processing module 10 employs only physical drivers such as the driver 13 in FIG. 1, the data processing system is limited to an application program associated with the physical driver 13 used therein. In other words, a data capture device is driven only by a physical driver so that video/audio data provided from the data capture device is processed only in association with an application program for the physical driver.

Also, in a conventional video processing system, video or audio data is usually stored in a data storage device in a sequential manner. When a user needs to search for a particular video sequence, the user needs to perform a sequential search. The time period for performing a sequential search depends on the amount of the stored data to be searched. Thus, for large amounts of video or audio data retrieve times may be undesirable.

Therefore, a need exists for a system and method for handling a number of video channels simultaneously, and being able to search video data non-sequentially.

### SUMMARY OF THE INVENTION

According to an embodiment of the present invention, a video monitoring system comprises a plurality of DVR servers, each DVR server receiving a corresponding plurality of video signals, a control processor for receiving the plurality of video signals from the DVR servers, concurrently processing the video signals, and selectively paritioning the video signals into signals of corresponding DVR servers, and at least one client station remotely disposed from the plurality of DVR servers for receiving at least one of the plurality of video signals.

The control processor comprises a logical channel mapper for receiving the plurality of video signals from the DVR servers and for logically mapping the video signals into a virtual device driver supporting an application of the vidoe monitoring system.

The client station includes means for receiving the pluralty of video signals directly from a DVR server or indirectly from the control processor.

A key frame index corresponding to an individual video signal is received by the client station, wherein the key frame index comprises key frame pointers, wherein the client station makes a request for a portion of the individual video signal, wherein the request comprises a key fram pointer of the key frame index.

At least one video signal is associated with a corresponding audio signal, wherein the corresponding audio signal is received by the client station concurrently with an assoicated video signal.

According to an embodiment of the present invention, a method for key play base transfer of a video between a server and a client over a network comprises initializing a session between the server and the client, wherein a key frame index is transferred to the client from the server. The method further comprises receiving a client request for content at the server, wherein the request comprises a key frame pointer and a parameter specifing a packet length, and sending a packet to the client in response to the request for content from the server, wherein the packet is a variable length according to the parameter.

The packet comprises a plurality of frames of a video stream.

The method performs redundant processes at the server. The redundant process is a seek process. The server performs as a database engine processing client requests and transmitting preprocessed video packets to the client.

The method comprises servcing a plurality of clients, wherein each client is allocated at least one thread by the server.

According to an emobidment of the present invention, a video processing system for processing data from a plurality of video sources comprises a plurality of analog-to-digital encoding chips for receiving analog video input signals from the video sources. The system comprises a composite-making-chipset for combining digital signals from each of the analog-to-digital encoding chips, wherein the composite-making-chipset outputs an analog signal representing a composite of the signals from the video soures. The system further comprises a PCI video encoder, wherein the analog signal from the composite-making-chipset is converted to a digital signal, wherein a video ouput is a portioned into a plurality of digitized video signals, each corresponding to a respective one of the video sources.

Each analog-to-digital encoding chip is associated with one digitized video signal. Each digitized signal comprises a resolution of aproximately the analog video input to the analog- to-digital encoding chip. The composite-making-chipset is a digital-to-analog converter.

The video output is stored in a database. The database comprises a video data file specifiying a start indentifier, a mask corresponding to a key frame and an inteval between frames of a video, a key information file comprising a pointer to the key frame of a corresponding video data file, and a master index file comprising a pointer to the video data file and a pointer to the key information file. The video processing system further comprises a client for requesting a session and requesting video data, and a server for accessing the database upon receiving a client request and sending to the client a packet comprising video frames. The server preforms data processing for the client. The client receives one key frame during the session.

According to an embodiment of the present invention, a method for key play base transfer of a video between a server and a client over a network comprises sending client credential to a server, requesting master unit information from the server, and sending master unit information comprising information for at least one video unit, coupled to the server, to the client. The method comprises selecting the at least one video unit according to the master unit information, requesting key information corresponding to the at least one video unit, and sending the key informaiton for the at least one video unit to the client. The method comprises creating, at the cleint, a remote unit object according to the master unit information and the key information, setting, at the server, a current state to a value corresponding to the at least one video unit, and requesting key-frame pointer information corresponding to the at least one video unit from the server.

The method comprises playing video supplied by the at least one video unit according to a client video request comprising key frame pointer information.

The method comprises determining a client video request is out-of-unit state, and shifting, at the server, the current state to a value corresponding to a second video unit upon determining that the client request is out-of-unit state by designating unit information from a client stored master index information. Shifting further comprises resetting, at the server, the current state to a second video unit, and sending key information to the client corresponding to the second video unit.

### BRIEF DESCRIPTION OF THE DRAWINGS

Preferred embodiments of the present invention will be described below in more detail, with reference to the accompanying drawings:

FIG. 1 is a block diagram illustrating a video data processing system applicable to a conventional monitoring system;

FIG. 2 is a block diagram illustrating an audio/video (A/V) data processing system applicable to a remote monitoring system according to a preferred embodiment of the present invention;

FIG. 3 is a block diagram illustrating the A/V data capture unit in FIG. 2 according to a preferred embodiment of the present invention;

FIG. 4A is a block diagram illustrating the database control unit in FIG. 2 according to a preferred embodiment of the present invention;

FIG. 4B is a schematic diagram for describing formation of event data according to the present invention;

FIGS. 5A and 5B are comparative block diagrams for describing a static zoom and a dynamic zoom according to the present invention;

FIG. 6 is a diagram of a device for combining video signals according to an embodiment of the present invention;

FIG. 7 is a diagram of a database structure for storing video signals according to an embodiment of the present invention;

FIG. 8 is a flow chart of a method of video playback according to an embodiment of the present invention;

FIG. 9 is a flow chart of a method of communication between a client and an A/V data capture unit according to an embodiment of the present invention;

FIG. 10 is another flow chart of a method of communication between a client and an A/V data capture unit according to an embodiment of the present invention;

FIG. 11 is a diagram of a system for video recording and playback according to an embodiment of the present invention; and

FIG. 12 is a diagram of a system according to an embodiment of the present invention.

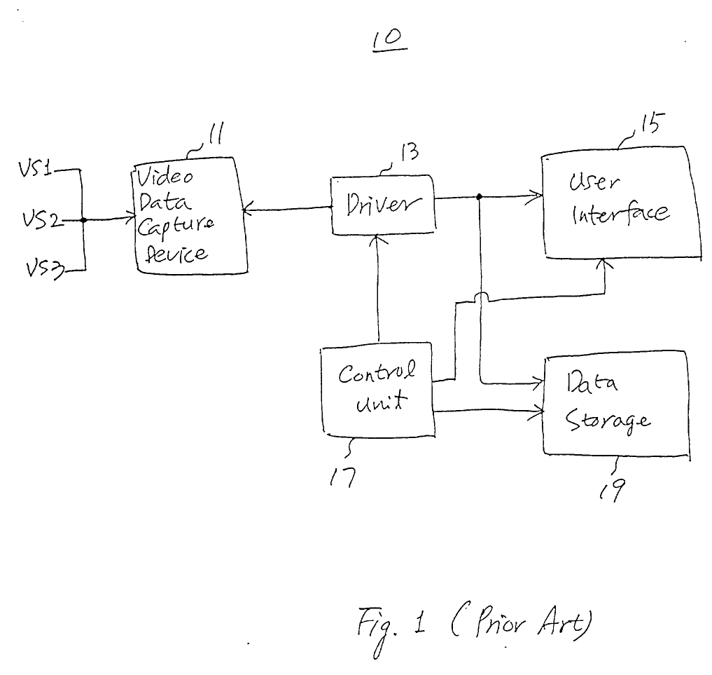

### DETAILED DESCRIPTION OF PREFERRED EMBODIMENTS

The present invention relates to a system and method of processing audio/video (A/V) data captured by multiple A/V sources by employing features such as high speed capturing and recording of A/V data, high speed data streaming, logical channel mapping, etc. The invention also relates to a remote monitoring system employing the system and method of processing A/V data, which has features such as a quick search of stored A/V data using a text query, more flexible screen editing, etc.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

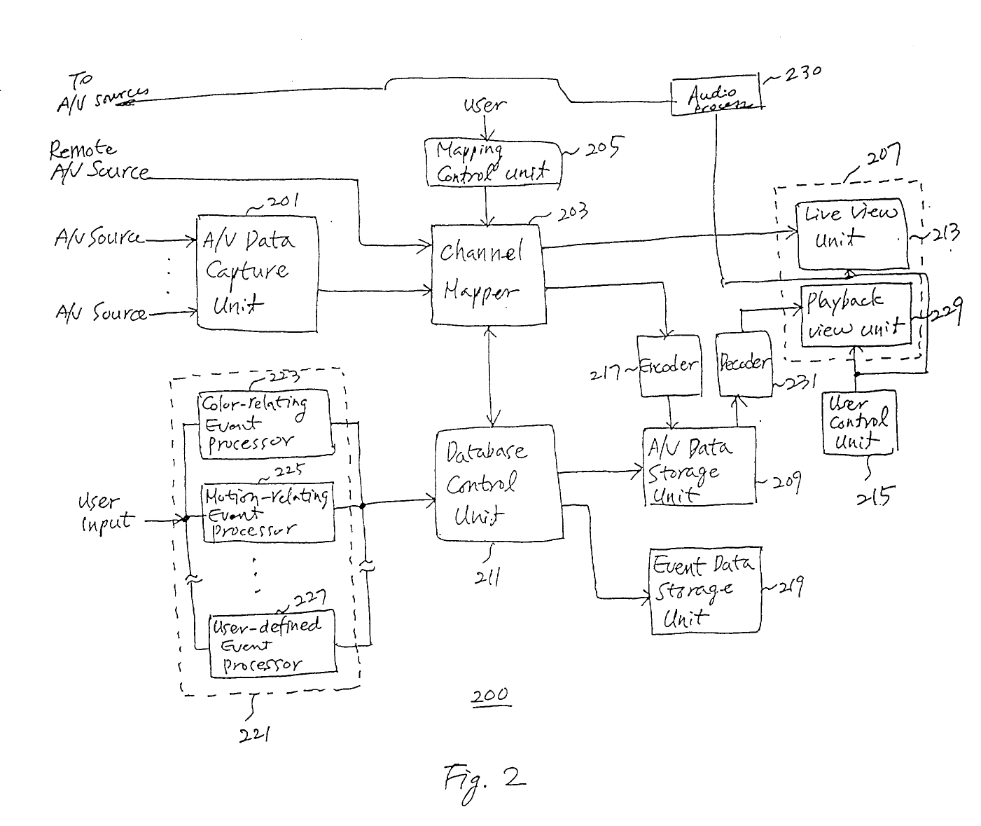

Referring to FIG. 2, an A/V data processing system 200 comprises A/V sources. The A/V sources provide A/V signals from one or more monitored areas. The number of A/V sources can vary depending on the number of areas to be monitored and/or a number of target objects at the monitored areas. The audio and video sources can include, for example, microphones and cameras. The A/V signals from the A/V sources can be provided to an A/V data capture unit 201. The A/V data capture unit 201 can process the captured A/V signals from the A/V sources to produce digital A/V data. The A/V data capture unit 201 can perform functions including a conversion of analog A/V signals into digital A/V data.

The A/V data processing system 200 further comprises a channel mapper 203. The channel mapper 203 can receive digital A/V data provided from the A/V capture unit 201 for logically mapping the input data into virtual device drivers, which are logically or virtually created in association with various application programs for a monitoring system. The channel mapper 203 can receive A/V data from remote A/V sources via a communication network such as the Internet. The channel mapper 203 may be implemented by hardware or software, or a combination thereof. The channel mapper 203 receives control data from a mapping control unit 205 to control, set up, and/or modify operation and programs in the channel mapper 203.

The data processing module 200 comprises a display unit 207 for displaying A/V data provided from the channel mapper 203. The display unit 207 preferably has a live view unit 213 and a playback view unit 229. The live view unit 213 displays video data in live view, and the playback view unit 229 displays recorded video data. In the live view unit 213 and the playback view unit 229, a screen may have multiple windows each of which displays video data transmitted via a corresponding channel from a video source (e.g., a camera).

The display unit 207 receives control data from a user control unit 215 accessed by a user. By sending the control data using the user control unit 215, a user can set up and/or modify sizes and locations of windows on a screen, and designate certain windows to particular channels or A/V sources.

The user control unit 215 can set one or more of the windows to display video data transmitted from remote A/V sources through a remote communication network. Under the control of the user control unit 215, a screen on the live view unit 213 can have multiple windows, some of which display video data provided via local channels from local video sources and others displaying video data provided via remote channels from remote video sources. While the conventional monitoring systems have limited number of windows on a screen and the windows each have a fixed size, the A/V monitoring system of the present invention comprises a screen edit function allowing a user to configure any number of windows on a screen and to restore them when needed. For example, the size of a window can be controlled by a clickable control. Information for a current screen layout can be saved into a file.

The display unit 207 can comprise audio devices, such as speakers, to output sound in response to audio data provided via the local and remote channels from the local and remote audio sources. Preferably, the live view unit 213 comprises speakers to operate in response to live audio data provided from the channel mapper 203, and the playback view unit 229 comprises speakers to operate in response to audio data retrieved from recorded audio data. The audio device in the display unit 207 can be controlled by the user control unit 215. Thus, a user can locally and remotely monitor and communicate using the local and remote A/V sources and the display unit 207. For example, when a noise (e.g., alarm sound) is detected at a remote site, a monitoring station operator (not shown) can activate a remote video source to scan the available channels for audio in a listen-only mode. Upon determining which channel carried the noise, the operator can change to a listen-and-talk mode and a proper announcement can be made to handle the situation at the remote site.

The A/V data provided via the local and remote channels can be stored in an A/V data storage unit 209 under control of a database control unit 211. For the process of storing A/V data in the A/V data storage unit 209, the A/V data output from the channel mapper 203 can be encoded or compressed by an encoder 217. When the encoded A/V data is stored in the storage unit 209, locations to be stored and the amount of data to be stored in each location can be determined by the database control unit 211. The encoder 217 has separate encoders for video data and audio data, respectively.

The database control unit 211 controls storing and retrieving event data into and from an event data storage unit 219. Event data can represent a single event, multiple events, a single object or multiple target objects defined by a user. Event data stored in the event data storage unit 219 can be associated with A/V data stored in the A/V data storage unit 209 in terms of events defined by a user.

A user can define events and/or objects in areas to be monitored by providing an event processor 221 with input data setting forth criteria for each event and/or object. The event processor 221 comprises multiple sub-processors, each sub-processor for producing particular event texts, each event text represents a target object or event defined by a user. For example, a color-relating event processor 223 receives input data defining color-related events, where each event is defined in association with particular colors of target object(s). A motion-relating event processor 225 receives input data defining motion-related events, where each event is defined in association with particular movement of target object(s). Thus, the color-relating event processor 223 and the motion-relating event processor 225 generate color-relating event texts and motion-relating event texts, respectively. The event processor 221 can include a user-defined event processor 227 for defining each event in accordance with a user definition or set up for each event or object at a specific area. It should be noted that the event processor 221 can include sub-processors other than the color-relating and motion-relating and user-defined event processors 223-227.

The event processor 221 can provide the event texts to the database control unit 211, which produces event data to be stored in the event data storage unit 219. The event data can be stored in association with A/V data provided from the channel mapper 203. Each event can be associated with a particular A/V data provided through a particular logical or virtual channel. The database control unit 211 controls the storing of certain event data and A/V data associated with the event data in the event data storage unit 219 and the A/V data storage unit 209, respectively. Thus, a query can be performed with respect to an event by finding event data representing the event and retrieving A/V data associated with the event data. The retrieved A/V data can be transferred to the display unit 207. Then, the playback view unit 229 in the display unit 207 displays video data provided from the A/V data storage unit 209. The A/V data stored in the A/V storage unit 209 can be compressed by the encoder 217, and the A/V data retrieved from the A/V storage unit 209 can be decompressed by a decoder 231.

When a user inputs data to define each event in the event processor 221, the data can be composed with one or more texts. For example, an event or object relating to a color can be defined by setting the event data as “red color”, and an event or object relating to motion can be defined by setting the event data as “horizontal movement from the left to the right”. By combining the event data relating to color and motion, a specific event or object can be defined such as, “red color and horizontal movement from the left to the right”. Since an event or object may be defined with texts, a user can find event data associated with the texts from the event data storage unit 219 by making a “text query”, a search of the event data using the texts defining certain events or objects.

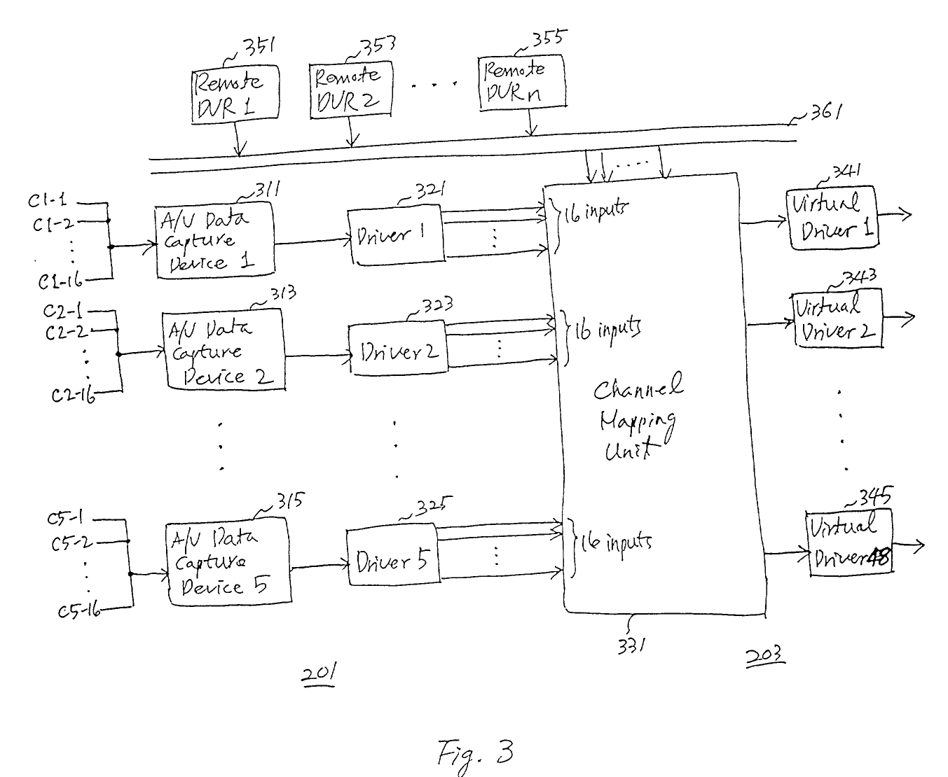

Referring to FIG. 3, a block diagram is provided for describing the A/V data capture unit 201 and the channel mapper 203. The A/V data capture unit 201 comprises multiple A/V data capture devices 311-315, each receiving A/V signals from multiple A/V sources (C1-1 to C5-16) such as cameras and microphones. Each of the A/V data capture devices can be associated with a driver to drive the data processed in a corresponding A/V data capture device in accordance with an operating system of the A/V monitoring system of the present invention.

The A/V data capture unit 201 employs, for example, five (5) A/V data capture devices 311-315, each receiving A/V signals from, for example, sixteen (16) A/V sources. The number of A/V data capture devices and the number of A/V sources can vary up to five (5) per an A/V capture unit and sixteen (16) per an A/V data capture device. Each of the A/V data capture devices performs a analog-to-digital (A/D) convert function with respect to A/V analog signals from associated A/V sources to generate digital A/V data.

Assuming that the data process of A/V signals in an A/V data capture device is performed at the speed of 30 frames per second, the data process speed in the A/V data capture unit 201 becomes 150 frames per second.

The A/V data capture unit 201 includes multiple drivers 321-325, each for driving the respective A/V data capture devices 311-315. Each of the drivers 321-325 can be associated with one or more of various application programs. A driver drives an A/V data capture device so that A/V data output from the A/V data capture device is processed in accordance with an application program associated with the driver. In FIG. 3, the A/V sources, the A/V data capture devices 311-315, and the drivers 321-325 comprise physical local channels. Since each A/V data-capture device can receive A/V signals from sixteen (16) A/V sources, each driver provides up to sixteen (16) inputs to the channel mapper 203. In this embodiment, the sixteen (16) A/V sources can be sixteen (16) cameras. The sixteen (16) inputs in the channel mapper 203 can have various kinds of physical connections with external devices such as USB camera, digital camera, Web camera, etc.

The channel mapper 203 comprises a channel mapping unit 331 and multiple virtual drivers 341-345. The channel mapping unit 331 receives digital A/V data provided from the drivers 321-325 and performs a mapping of the input A/V data into the virtual drivers 341-345. The channel mapping unit 331 can receive A/V data from remote A/V sources such as remote digital video recorders (DVRs) 351-355. Each of the remote DVRs can be a conventional DVR or an A/V monitoring system of the present invention. DVRs are cost-effective alternatives to traditional analog VCR systems with long-term, low-maintenance networked digital video. DVRs are scalable can can support multiple applications. Each DVR unit can support a number of cameras, for example, 4 to 16 cameras. A number of DVR systems can be deployed together as part of a network, for example, coupled by TCP/IP networked PCs. A/V data generated by the remote DVRs can be transmitted to the channel mapping unit 331 through a communication network 361, which includes, but is not limited to, a telephone line network, a cable line network, a digital subscriber line (DSL) network, a T-1 network, a wireless network and a global computer network for the Internet.

The virtual drivers 341-345 can be logical drivers, software drivers that are logically connected to drive input data and virtually created in association with various application programs. Each virtual driver 341-345 can be used to drive A/V data provided from the channel mapping unit 331 so that the various application programs can be implemented with respect to the A/V data. By providing the virtual drivers 341-345 to the system, virtual or logical channels can be formed between the channel mapping unit 331 and other peripheral devices such as a user interface and a data storage unit.

In FIG. 3, for example, the channel mapping unit 331 distributes the input data (e.g., maximum 80 inputs) into the forty-eight (48) virtual drivers 341-345. The number of virtual drivers can vary from one (1) to forty-eight (48). The mapping of the input data into the virtual drivers in the channel mapping unit 331 can be determined by data provided from the mapping control unit (205 in FIG. 2).

In FIG. 3, there can be up to eighty (80) physical local channels, each channel from a corresponding A/V source to an input to the channel mapping unit 331 through an A/V data capture device and a driver. Also, there can be physical remote channels each from a remote DVR to an input to the channel mapping unit 331 through the communication network 361. In this example, since there are five drivers 321-325 to drive the A/V data capture devices 311-315 in the physical local channels, only five application programs are available to the A/V data captured and processed by the physical local channels. In the channel mapper 203, however, the physical local and/or remote channels are mapped into the logical channels (e.g., forty-eight channels) so that the A/V data from the physical local/remote channels can be processed in association with additional application programs. Since there are, for example, forty-eight virtual drivers, each for the respective logical channels, forty-eight application programs can be implemented with respect to A/V data mapped in the channel mapping unit 331.

As a result, various application programs can be supported by the virtual drivers 341-345. For example, the remote channels can be mapped along with the local channels, and various screen editing is available in the display unit (207 in FIG. 2). Also, same A/V data can be processed in association with two or more different events by mapping a single physical channel into multiple logical channels. For example, A/V data on a single physical channel can be stored in a lower quality format in case that event A occurs, and stored in a high quality format in case that event B occurs.

Compared with the conventional monitoring systems where only one audio channel is provided for recording audio data in a storage unit, the A/V monitoring system of the present invention has multiple audio channels and video channels. In the system shown in FIGS. 2 and 3, for example, the system has forty-eight (48) logical channels each including a virtual driver. Using the audio channels according to the present invention, audio data transferred via audio channels (e.g., 9 audio channels) can be simultaneously recorded, and two-way audio communication can be performed simultaneously in all the audio channels.

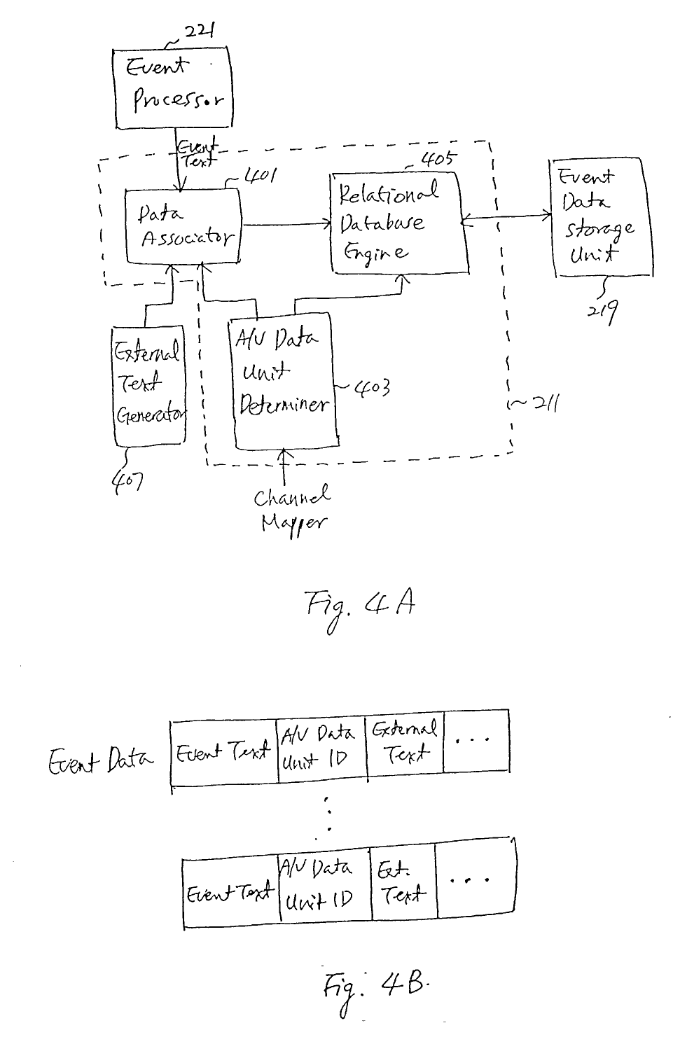

FIGS. 4A and 4B are block diagrams for describing a system and method of storing event data and performing a text query. In FIG. 4A, the database control unit 211 preferably comprises a data associator 401 for associating input data, an A/V data unit determiner 403 for providing A/V data unit ID to the data associator 401, and a relational database engine 405 for transferring event data to the event data storage unit 219.

The data associator 401 receives from the event processor 221 event texts each of which is obtained by defining an event or object. Each event can be associated with a logical channel. In other words, each event can be defined by the event processor 221 in association with one or more of the virtual drivers (341-345 in FIG. 3). The data associator 401 can also receive text data from an external text generator 407, which generates text data when an event occurs. For example, an automated-teller machine (ATM) located within a monitored area can generate text data relating to a transaction whenever a transaction occurs. The text data can be transferred to the data associator 401 through an extra channel.

The data associator 401 can receive text data from one or more external text generators. The data associator 401 can receive A/V data unit ID from the A/V data unit determiner 403 which receives A/V data from the channel mapper 203. Each A/V data unit ID identifies an A/V data unit having a predetermined amount, for example, 3 MB A/V clip.

Upon receiving event text, external text, and A/V data unit ID, the data associator 401 associates the input data with each other to form event data as shown in FIG. 4B. For the event data associated with an event, an event text defining the event, A/V data unit ID identifying an A/V data unit corresponding to the event, and external text relating to the event (optional) can be arranged to form a data packet. Such event data from the data associator 401 can be provided to a relational database engine 405 where the event data is organized in accordance with predetermined formats to be stored in the event data storage unit 219.

The event data storage unit 219 comprises a relational database for the event data, which is previously organized by the relational database engine 405. The relational database can be organized, for example, as a set of formally described tables from which event data can be accessed or reassembled in different ways without having to reorganize the database tables. The standard user and application program interface to a relational database is the structured query language (SQL). SQL statements may be used for interactive queries for information from a relational database. In addition to being relatively easy to create and access, a relational database has the important advantage of being easy to extend. After the original database creation, a new data category can be added without requiring that all existing applications be modified. In other words, a relational database is a set of tables containing data fitted into predefined categories. Each table comprises one or more data categories in columns. Each row comprises an instance of data for the categories defined by the columns.

When a user searches A/V data stored in the A/V data storage unit (209 in FIG. 2), an object or event can be found by performing a sequential search with respect to the stored A/V data. The sequential search can be performed by retrieving the stored A/V data sequentially and finding a target object and/or event during the retrieval. Such sequential search is well known in the art, thus a detailed description thereof is omitted.

In addition to the sequential search, the system of the present invention allows a user to perform a quick search such as a text query using the event data stored in the event data storage unit 219. In a text query, a user inputs a query text to a processor (now shown) where the query text is compared with event texts of the event data stored in the event data storage unit 219 until finding one or more event texts corresponding to the query text.

Since each event text is associated with A/V data unit ID, corresponding A/V data can be identified by the A/V data unit ID and retrieved from the A/V data storage unit 209. Then, the retrieved A/V data is decoded and transferred to the playback view unit (229 in FIG. 2). As a result, a target object or event for the text query is displayed on one or more windows of a screen in the playback view unit 229.

While a time period for performing the sequential search can depend on the amount of A/V data stored in the A/V data storage unit 209, a time period for performing the text query can be independent of the amount of the stored A/V data. Thus, a user can search an object or event from a large amount of stored A/V data at a high speed by using the text query.

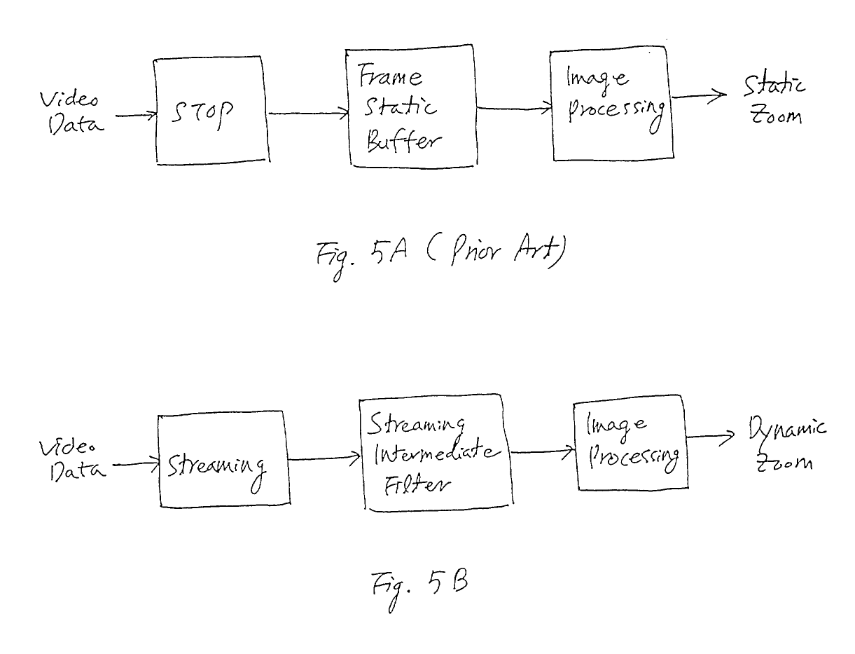

FIGS. 5A and 5B are comparative block diagrams for describing a static zoom and a dynamic zoom according to the present invention. The static zoom has sizes determined by in hardware such as a capture board or a graphic adapter. In contrast, the dynamic zoom has sizes determined by in software and user operation.

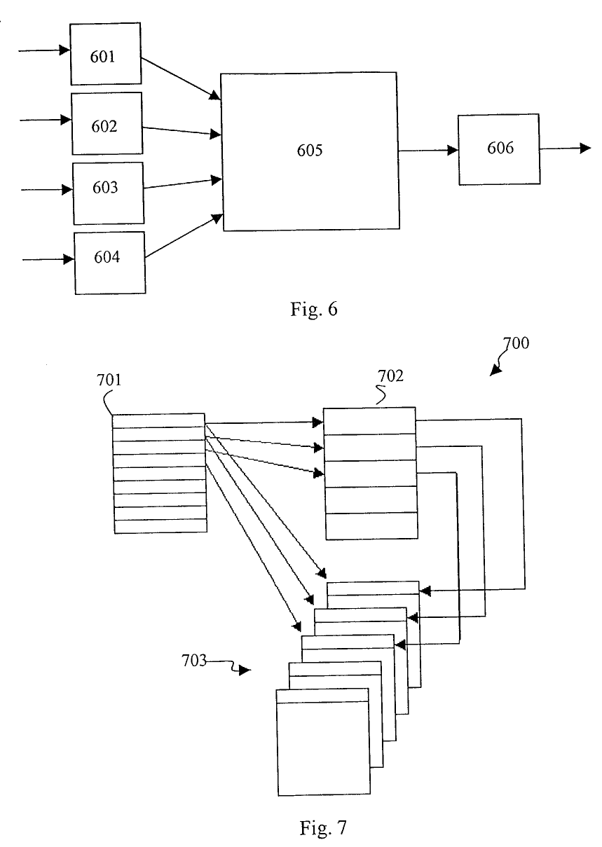

According to an embodiment of the present invention, a system is provided for improving the frame rate of video over a network. Referring to FIG. 6, a video capture card comprises a plurality of analog-to-digital converter (ADC) encoding chips 601-604 for receiving analog video inputs from video sources such as a DVR. The video capture card can be implemented in a device such as a personal computer or mini-computer. The system can implement any number of ADC encoding chips. The system further comprises a composite-making-chipset 605, e.g., the A-Logics AQ-424, for combining digital signals from each of the ADC encoding chips 601-604. The digital signals can be, for example, four digitized videos at a high resolution, such as 320×240 and a rate of about 30 frames per second each, for a total resolution of about 320×240×4. The composite-making-chipset chipset 605 outputs an analog video signal comprising the video signal supplied by each of the ADC encoding chips 601-604. Further, the composite-making-chipset 605 acts as a digital-to-analog converter (DAC). Thus, the output of the composite-making-chipset 605 can be, for example, an analog signal of 640×480×1 and 30 frames per second. The output of the composite-making-chipset 605 is processed by a PCI video encoder 606, wherein the analog signal is converted to a digital signal, and the video feed is defined as four digitized video signals at a high resolution, such as 320×240 and about 30 frames per second each. The PCI video encoder can be, for example, the Conexant BT878A. The digital signal can be sent over a PCI bus, in a split PCI burst of 640×480, wherein the four digitized video signals are parsed and sent separately.

According to an embodiment of the present invention, the driver for the device can be written as, for example:

// initialize all chip sets to encode/decode

| | |
|---|---|
| // | 1) Initialize ADC-1 (decoding) |

IniAdc_1_0( ); //first
IniAdc_1_1( ); //second
IniAdc_1_2( ); //third
IniAdc_1_3( ); //fourth

| | |
|---|---|
| // | 2) Initialize DAC-1 (encoding) |

| | |
|---|---|
| // | Even/odd field realigned |
| // | - Video_0 : Set Left Half of even |
| // | - Video_1 : Set Right Half of even |
| // | - Video_2 : Set Left Half of odd |
| // | - Video_3 : Set Right Half of odd |

IniDac_1( );

| | |
|---|---|
| // | 3) Splitted PCI burst |

| | |
|---|---|
| // | - Initialize to burst 640×480 |

IniAdc_2( );

| | |
|---|---|
| // | - Set PCI burst instruction |

ULONG iOdd=0;
F:: SetSyncForOdd(iOdd++); //sync until the first odd line
ULONG iEven=0;
SetSyncForEvenOdd(iEven++) ; //sync until the first even line
ULONG inc=640*480*3; //use NTSC SQ RGB24
for(ULONG line=0; line<240; line++) {

BurstEvenFromHline320×240FirstHalf(iEven++, inc−320*3−
320*240*3);
BurstEvenFromHline320×240SecondHalf(iEven++, inc−320*3);
inc−=320*3;

);
for(line=0; line<240; line++) {

BurstOddFromHline320×240FirstHalf(iOdd++, inc−320*3−
320*240*3);
BurstOddFromHline320×240SecondHalf(iOdd++, inc−320*3);
inc−=320*3;

);
SetSyncForEndOdd( ); //sync until the end of odd line
ChainOddToEven( );
SetSyncForEndEven( ); //sync until the end of even line
JumpTo F::
End

As expressed in the code, each chip set of the video input is initialized for analog-to-digital decoding. Each video input signal is then decoded. The composite-making-chip set is initialized for digital-to-analog encoding. The video field of the composite-making-chip set is divided among the videos, for example, a first video set to be encoded in a left half and even lines of a composite signal. The second video set to be encoded in the right half and even lines of the composite signal. The third and forth videos being encoded in the odd lines of the left and right halves, respectively. The composite signal can be processed by the split PCI burst chip, wherein the output can be displayed by an appropriate application. For example, an application that can synchronize the split PCI burst to render a complete image.

According to an embodiment of the present invention, the digital signal comprising the four video signals can be saved in a database 700. Referring to FIG. 7, the database comprises file structures including a master index file 701, key information files 702, and video data files 703.

The master index file 701 comprises a pointer to data, for example, a key information file 702 or video data file 703, and a timer log, for example to specify the beginning and end of a video file. The master index file 701 further comprises a state mask for locking and/or searching attributes globally, directory information corresponding to a requested video data file, and a logical channel for providing a logical device buffer.

The structure of the master index file can be expressed as, for example,

struct _MASTER_UNIT_INFO {

| | |
|---|---|
| ULONG idx; | / / => pointer to key information file |
| | / / and video data file |
| LONGLONG tllBegin; | / / beginning GMT of the specific Key |
| | / / and Video file as milliseconds |
| LONGLONG tllEnd; | / / ending GMT of the specific Key and |
| | / / Video file as milliseconds |
| USHORT maskState; | / / the current state mask to lock or |
| | / / search attributes globally |
| CHAR drv; | / / disk drive location of the specific |
| | / / key and video data file |
| BYTE iChan; | / / logical channel to map logical |
| | / / device buffer |
| | / / (local/remote/external map) |

};

The key information files 702 each comprise a pointer to a video data file, a time log, a state mask, a security field and a mask to supporting dynamic searches.

The structure of the key information file can be expressed as, for example,

struct _K_HEADER {

| | |
|---|---|
| ULONG fOffset; | // pointer to video data file |
| LONGLONG tAbsMs; | // Beginning GMT as milliseconds |
| BYTE maskKeyState; | // mask to show triggered, cached, etc. |
| BYTE acc; | // secured or public to restrict |
| | // media access security |

LONGLONG maskllMot48BlockAcc; // to support dynamic search

};

The video data files 703 each comprises an identifier for the start of the file, a mask indicating a key frame, and an interval between video frames, for example, between about 33 and 333 milliseconds. Each video data file can be, for example a 15 MB unit. The video data file further comprises a pointer to a key information file, a time stamp specified according to the interval, and a length of the compressed data. To search backwards and validate the beginning of each frame, the previous frame is also compressed data.

The structure of the video data files can be expressed as, for example,

struct _F_HEADER {

| | |
|---|---|
| ULONGLONG fHeader; | // video start identifier to recover |
| | // damaged unit or check healthy |
| BYTE maskType; | // mask key frame or not key frame |
| USHORT interval; | // for smooth play forward and backward |
| | // milliseconds/10 |
| ULONG idxToKey; | // pointer to key information file |
| LONGLONG tAbsMs; | // GMT for the specific frame in |
| | // milliseconds |
| USHORT len; | // actual compressed data length to |
| | // be used in decompressor |
| USHORT prevCompLen; | // prv compressed length to be used |
| | // to locate previous frame |
| }; | |

Within a data server, the master index file 701 can be resident in memory, the key information files 702 can be stored in memory resident on demand (e.g., cache), and the video data files 703 can be stored in memory resident on demand for a local access method, and also on disk resident for a remote access method.

Video recording and playback from a database is distinct from the method used for text or binary based databases. For example, video databases need the following attributes satisfied for either local or remote access; a specified seek method, an indication of sequential play and an indication of key frame play. The specified seek method can be, for example, by time, by mask, and/or be source. The play indications for sequential play and key play can be specified as forward or backward play.

For remote access to the database, a predetermined minimum index can be loaded into a memory of the client, for example, 1 to 15 k, comprising all key frame information. Thus, remote playback requests can comprise a single pointer to a key frame that exists in the video data file, rather than downloading an entire video file. Other information can be processed by a set of distributed local DVR playback functions. The use of pointers can produce performance on par with local playback, for example, under 25 kbytes/sec bandwidth.

For local play, the local computer consumes processing power for the database engine and the user interface. In contrast, for remote play, DVR implements a playing engine while the client processes the user interface functions. Thus, a distributed processing environment can be established wherein the DVR and the client each contribute to playback. Inside this distributed processing system, traffic can be minimized, specifically the client can fetch timely video data substantially instantaneously by requesting 4 bytes of video data pointer information.

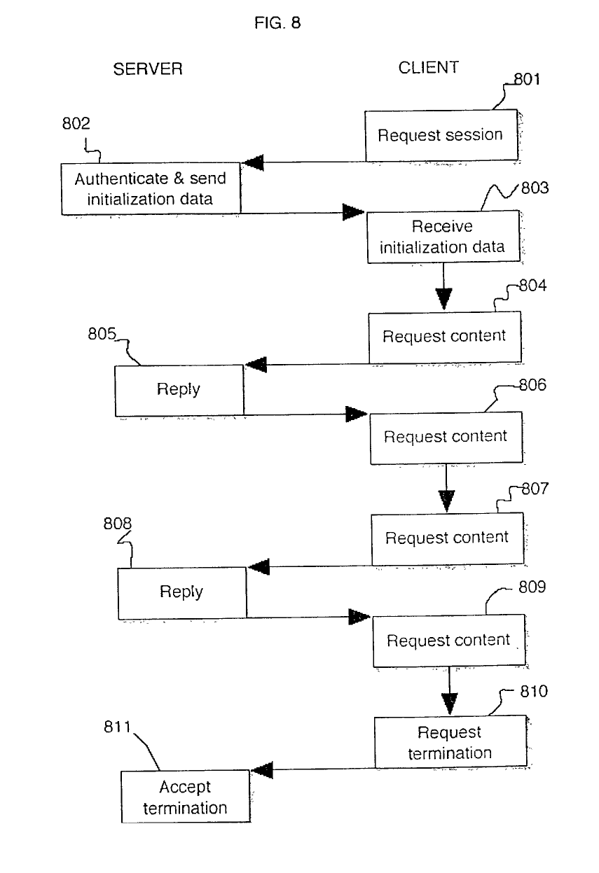

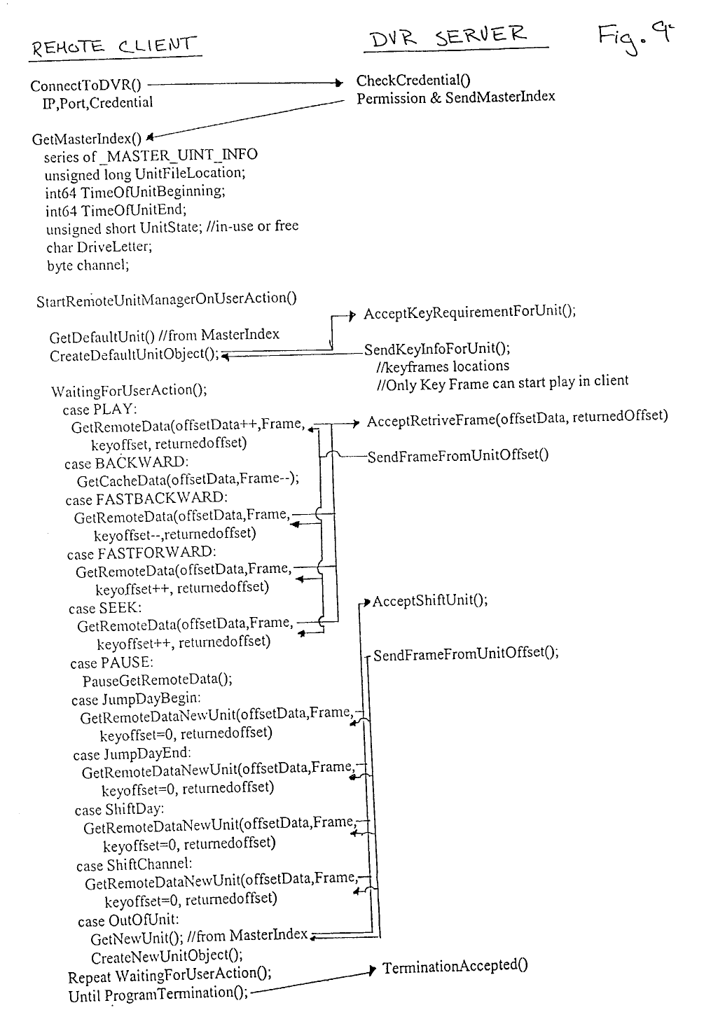

Referring to FIG. 8, for playback and constant live switching at a remote client, the client requests a session from a server 801. The server authenticates the client and responds by sending a minimum amount of data, for example, specifying initialization data 802 comprising the key frame index. The client receives the initialization data 803. The client can make requests of the server as the client becomes prepared to handle the data. Thus, each client request, 804 and 807 can be replied to with a packet comprising a number of frames 805 and 808.

For live transmissions, only the first packet will comprise a key frame. The session can use the key frame to build all subsequent frames. This can reduce the average frame size by five (5) times or more. However, a new key frame can be sent when needed to continue a session, for example, where the client changes a request attribute. The request attribute can be, for example, changing a camera selection to view a new area, adjusting the quality or size of the image, or changing camera combinations, e.g., a four camera array to a nine camera array. The client can notify the server that no more requests will be made 810 and the server can accept client terminations 811.

The size a each packet can be varied automatically according to the client's requests. For example, the client request can specify an available bit-rate to which the server can tailor the packet size by varying the image quality and frame size. The server can adjust other attributes as well, for example, varying the number of frames per packet. Thus, playback can appear as a real-time transmission wherein transmission latency is substantially reduced or eliminated. The variable packet length can reduce communication time. There is no fixed data length for sending video data packets.

For communications systems comprising home cable network, DSL, or local area network, the remote player can have better performance than local player due to the separation of video information and the data file, and the shared computer resources between the server (DVR) and the client (remote player).

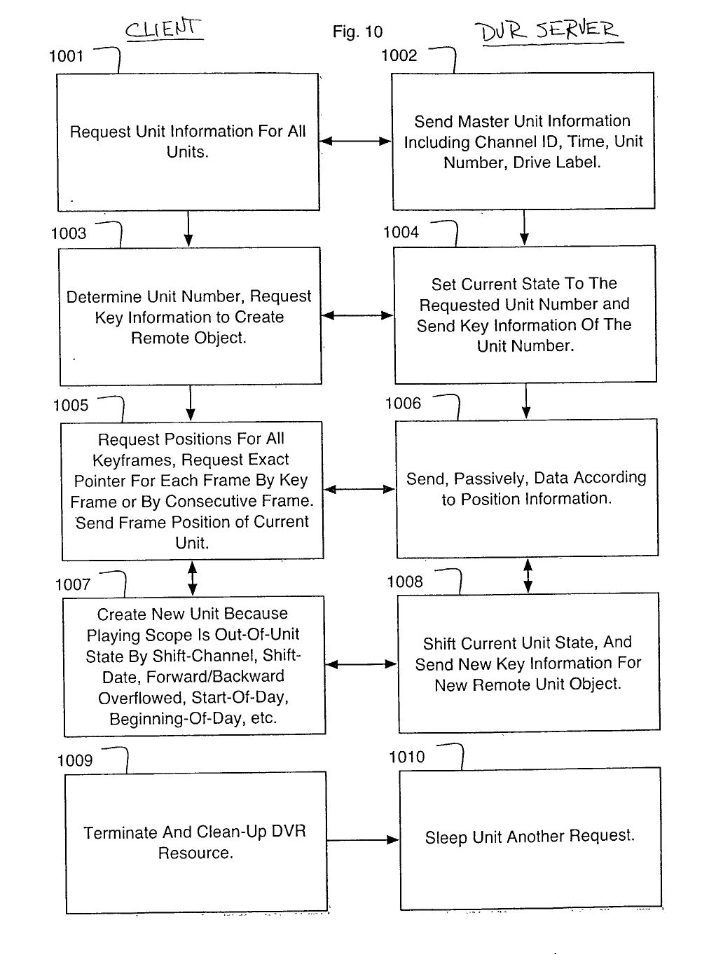

Referring to FIGS. 9 and 10, during remote playback a client supplies credentials and requests master unit information from a DVR recording server 1001. The DVR recording server sends master unit information for all of the DVR video units in the system 1002. Based on the master unit information, the client can determine a DVR video unit number for a desired DVR video unit and request key information corresponding to the desired DVR video unit 1003. The client can create a remote unit object based on the master unit information and the key information 1003. The DVR recording server sets a current state to the unit number of requested key information, and sends the key informaiton for the desired unit 1004. The client can request information about the key-frame pointers corresponding to the desired unit for the current unit object 1005. The client can play any video unless a user request is out-of-unit state 1007. The client's request comes to out-of-unit by, for example, new date, new channel, backward overflow, or forward overflow. A client request can induce the DVR server to shift the current state to a new unit by designating unit information from a client's stored master index information, this is a shift-unit request 1007. Upon the shift-unit request from client, the DVR server resets the current state to the new unit and sends new key information to the client 1008. The client maintains the key frame information for new unit. The client can request a termination of the object and reliquish DVR resourses allocated to servicing the client 1009. The DVR can wait for additional requests 1010.

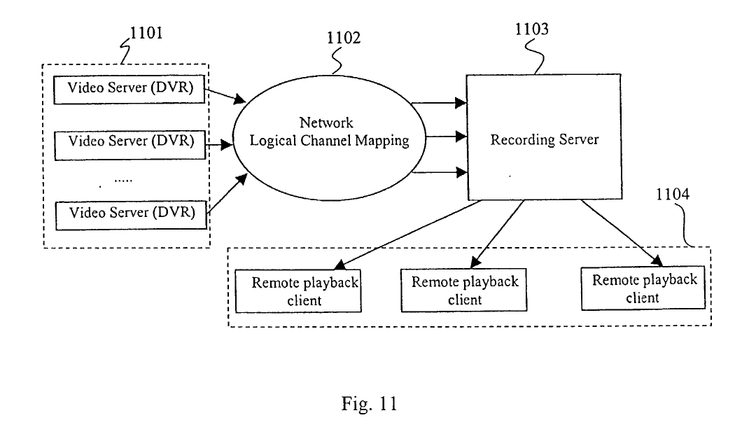

According to an embodiment of the present invention, a recording server can be implemented separately from the video capture device(s). Referring to FIG. 11, one or more video capture devices 1101, e.g., DVRs, send signals to a networked logical channel mapping node 1102. The channel mapping node 902 forwards the signals to the recording server 1103. The recording server 1103 can be remote from the video capture devices 1101, for example, implemented as a central remote recording device, protected from hazards of the recording cite. Thus, the recording device 1103 will not be affected by an accident at the site being recorded and the data can be preserved. The video signal can be viewed from one or more remote playback clients 1104.

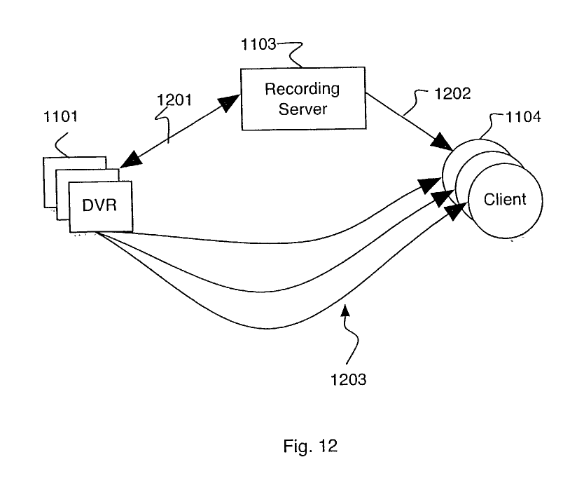

Referring to FIG. 12, clients 1104 can request 1202 that the server 1103 process data, for example, for a large amount of video data. Redundant processes are an example of data that can be processed by the server 1103. For example, seek processing is a redundant process. Likewise, a sequential seek to locate some attribute like motion detected frame is a redundant process.

Where multiple clients are making requests 1202 of the server 1103, multiple simultaneous client requests can be responded to by the server 1103 with concurrent or parallel threads 1202.

The connection 1201 between the DVRs 1101 and the server 1103 can be bi-directional. Thus, the attributes of the DVRs can be changed and video can be streamed to the recording server 903. For live playback 1203, each DVR 1101 can stream one or more threads to a corresponding number of clients 1104.

Having described embodiments for an system and method of processing audio/video data in a remote monitoring system, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A video monitoring system comprising;
a plurality of DVR servers, each DVR server receiving a corresponding plurality of video signals;
a control processor for receiving the plurality of video signals from the DVR servers, concurrently processing the video signals., and selectively paritioning the video signals into signals of corresponding DVR servers; and
at least one client station remotely disposed from the plurality of DVR servers for receiving at least one of the plurality of video signals.

2. The video monitoring system of claim 1, wherein the control processor comprises a logical channel mapper for receiving the plurality of video signals from the DVR servers and for logically mapping the video signals into a virtual device driver supporting an application of the vidoe monitoring system.

3. The video monitoring system of claim 1, wherein the client station includes means for receiving the pluralty of video signals directly from a DVR server or indirectly from the control processor.

4. The video monitoring system of claim 1, a key frame index corresponding to an individual video signal is received by the client station, wherein the key frame index comprises key frame pointers, wherein the client station makes a request for a portion of the individual video signal, wherein the request comprises a key fram pointer of the key frame index.

5. The video monitoring system of claim 1, wherein at least one video signal is associated with a corresponding audio signal, wherein the corresponding audio signal is received by the client station concurrently with an assoicated video signal.

6. A method for key play base transfer of a video between a server and a client over a network comprising the steps of:
initializing a session between the server and the client, wherein a key frame index is transferred to the client from the server;
receiving a client request for content at the server, wherein the request comprises a key frame pointer and a parameter specifing a packet length; and
sending a packet to the client in response to the request for content from the server, wherein the packet is a variable length according to the parameter.

7. The method of claim 6, wherein the packet comprises a plurality of frames of a video stream.

8. The method of claim 6, further comprising the step of performing redundant processes at the server.

9. The method of claim 8, wherein the redundant process is a seek process.

10. The method of claim 6, wherein the server performs as a database engine processing client requests and transmitting preprocessed video packets to the client.

11. The method of claim 6, further comprising the step of servcing a plurality of clients, wherein each client is allocated at least one thread by the server.

12. A video processing system for processing data from a plurality of video sources comprising:
a plurality of analog-to-digital encoding chips for receiving analog video input signals from the video sources;
a composite-making-chipset for combining digital signals from each of the analog-to-digital encoding chips, wherein the composite-making-chipset outputs an analog signal representing a composite of the signals from the video soures; and
a PCI video encoder, wherein the analog signal from the composite-making-chipset is converted to a digital signal, wherein a video ouput is a portioned into a plurality of digitized video signals, each corresponding to a respective one of the video sources.

13. The video processing system of claim 12, wherein each analog-to-digital encoding chip is associated with one digitized video signal.

14. The video processing system of claim 12, wherein each digitized signal comprises a resolution of aproximately the analog video input to the analog-to-digital encoding chip.

15. The video processing system of claim 12, wherein the composite-making-chipset is a digital-to-analog converter.

16. The video processing system of claim 12, wherein the video output is stored in a database.

17. The video processing system of claim 16, wherein the database comprises:
a video data file specifiying a start indentifier, a mask corresponding to a key frame and an inteval between frames of a video;
a key information file comprising a pointer to the key frame of a corresponding video data file; and
a master index file comprising a pointer to the video data file and a pointer to the key information file.

18. The video processing system of claim 16, further comprising:
a client for requesting a session and requesting video data; and
a server for accessing the database upon receiving a client request and sending to the client a packet comprising video frames.

19. The video processing system of claim 18, wherein the server preforms data processing for the client.

20. The video processing system of claim 18, wherein the client receives one key frame during the session.

21. A method for key play base transfer of a video between a server and a client over a network comprising the steps of:
sending client credential to a server;
requesting master unit information from the server;
sending master unit information comprising information for at least one video unit, coupled to the server, to the client;
selecting the at least one video unit according to the master unit information;
requesting key information corresponding to the at least one video unit;
sending the key informaiton for the at least one video unit to the client;
creating, at the cleint, a remote unit object according to the master unit information and the key information;
setting, at the server, a current state to a value corresponding to the at least one video unit; and
requesting key-frame pointer information corresponding to the at least one video unit from the server.

22. The method of claim 21, furhter comprising the step of playing video supplied by the at least one video unit according to a client video request comprising key frame pointer information.

23. The method of claim 21, further comprising the steps of:
determining a client video request is out-of-unit state; and
shifting, at the server, the current state to a value corresponding to a second video unit upon determining that the client request is out-of-unit state by designating unit information from a client stored master index information.

24. The method of claim 23, wherein the step of shifting further comprises the steps of:
resetting, at the server, the current state to a second video unit; and
sending key information to the client corresponding to the second video unit.
